(19) United States
(12) Patent Application Publication
(10) Pub. No.: US 2010/0287049 A1
(43) Pub. Date: Nov. 11, 2010

(54) Apparatuses, Methods and Systems for Language Neutral Search

(76) Inventors: Armand Rousso, New York, NY (US); Steven Schwartz, Brooklyn, NY (US)

Correspondence Address: CHADBOURNE & PARKE LLP, 30 ROCKEFELLER PLAZA, NEW YORK, NY, 10112, US

(21) Appl. No.: 12/303,740

(22) PCT Filed: Jun. 6, 2007
(86) PCT No.: PCT/US07/70552

§ 371 Date: Jul. 28, 2010

Related U.S. Application Data
(60) Provisional application No. 60/804,150, filed on Jun. 7, 2006.

(51) Int. Cl. G06F 17/30; G06F 3/048; G06Q 30/00

(52) U.S. Cl. 705/14.53; 715/764; 707/769; 707/723; 707/765; 707/E17.014

(57) ABSTRACT

The disclosure details the implementation of an apparatuses, methods, and systems for language neutral search. The disclosure teaches a language neutral search system, which provides a straightforward, unified, and transparent interface that automatically presents users with a search interface that is native to their own language. The language neutral search system, also, dynamically responds and provides search results in the user's native language. As such, this disclosure details, in one embodiment, search-enhancing mechanisms and interfaces that provide language specific search capabilities for searching computer systems, for example, on the World Wide Web. As such, the language neutral search system provides a mechanism allowing a broader audience to better interface and interact with various computer systems. By including such search-enhancing components, the language neutral search system empowers members of society to make use of facilities such as Accoona Corp.'s search site, thereby allowing it to become language neutral in its ability to interact with users.

### RELATED APPLICATIONS

This application claims all rights of priority under 35 U.S.C. §119 to provisional patent application No. 60/804,150 filed Jun. 7, 2006 and titled “APPARATUSES, METHODS AND SYSTEMS FOR LANGUAGE NEUTRAL SEARCH,” Attorney Docket No. 17253-015PV.

Applicant hereby claims priority under 35 USC §119 for U.S. provisional patent application Ser. No. 60/793,871 filed Apr. 20, 2006, entitled “APPARATUS, METHODS, AND SYSTEMS TO GENERATE, DISPLAY AND USE A VOICE-ENABLED TOOLBAR.”

Applicant hereby claims priority for Patent Cooperation Treaty patent application serial no. PCT/05/20545 filed Jun. 10, 2005, entitled “APPARATUS, METHOD AND SYSTEM OF ARTIFICIAL INTELLIGENCE FOR DATA SEARCHING.”

Applicant hereby incorporates by reference Cooperation Treaty patent application serial no. PCT/US06/13873 filed Apr. 12, 2006, entitled “APPARATUS, METHOD AND SYSTEM TO IDENTIFY, GENERATE, AND AGGREGATE QUALIFIED SALES AND MARKETING LEADS FOR DISTRIBUTION VIA ONLINE COMPETITIVE BIDDING SYSTEM.”

The entire contents of the aforementioned applications are herein expressly incorporated by reference.

### FIELD

The present invention is directed generally to an apparatuses, methods, and systems of data searching, and more particularly, to apparatuses, methods and systems for language neutral search.

### BACKGROUND

Current computer-based data searching techniques, such as Internet search engines or general computer search methods can return results successfully when there is an intersection of vocabularies as between: a user's inquiry and data source being searched (e.g., a web site's programmers, or a content copy's writer). As such, current search techniques limit the number of relevant results that may be returned. For example, a successful search result is returned when a searcher querying a search engine or a computer database uses the same keywords as did the programmer when writing the META tags for a web site, or the original author of the data source being queried.

### SUMMARY

Current user interfaces do not provide a straightforward, unified, and transparent interface for interacting with web search systems. As more and more information is placed on the web, and as more and more news and business entities make their information available on the internet, the conventional method of supplying search tokens and reading results is stifling potential user productivity gains. The mass of this content is further diversified and provided in a multitude of languages. Nevertheless, conventional search interfaces are not capable of easily, readily and transparently discerning a user's language.

The disclosure teaches a language neutral search system, which provides a straightforward, unified, and transparent interface that automatically presents users with a search interface that is native to their own language. The language neutral search system, also, dynamically responds and provides search results in the user's native language. As such, this disclosure details, in one embodiment, search-enhancing mechanisms and interfaces that provide language specific search capabilities for searching computer systems, for example, on the World Wide Web. As such, the language neutral search system provides a mechanism allowing a broader audience to better interface and interact with various computer systems. By including such search-enhancing components, the language neutral search system empowers members of society to make use of facilities such as Accoona Corp.'s search site, thereby allowing it to become language neutral in its ability to interact with users.

### BRIEF DESCRIPTION OF THE DRAWINGS

The accompanying appendices and/or drawings illustrate various non-limiting, example, inventive aspects in accordance with the present disclosure:

FIG. 1A is of an overview flow diagram illustrating an embodiment of the language neutral search system;

FIG. 1B is a flow diagram illustrating aspects of user indicia collection for one embodiment of the language neutral search system;

FIG. 1C is a wire frame diagram illustrating an interface aspect of one embodiment of the language neutral search system;

FIG. 1D is a screen image diagram illustrating an interface aspect of one embodiment of the language neutral search system;

FIG. 2 is a flow diagram illustrating details of indicia analysis and user language preference determination for an embodiment of the language neutral search system;

FIG. 3 is a flow diagram illustrating aspects of the search process in an embodiment of the language neutral search system;

FIG. 4 provides screen image diagrams illustrating aspects of the language neutral search system;

FIGS. 5A-5B provide screen image diagrams illustrating additional aspects of the language neutral search system;

FIG. 6 is of a block diagram illustrating embodiments of the language neutral search system controller.

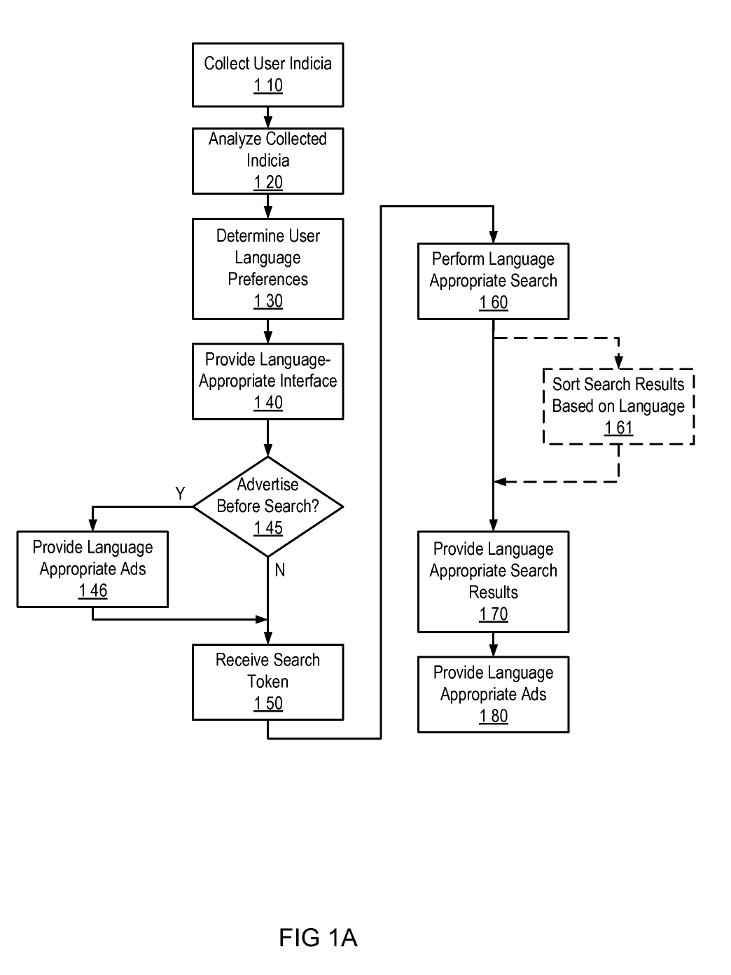

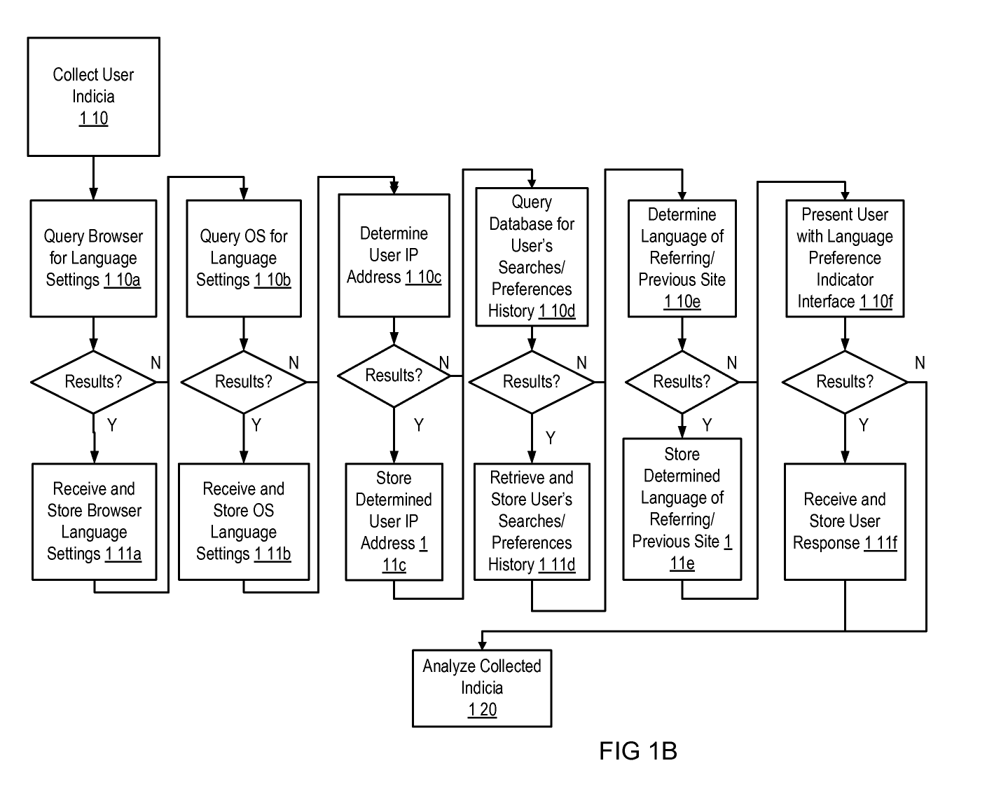

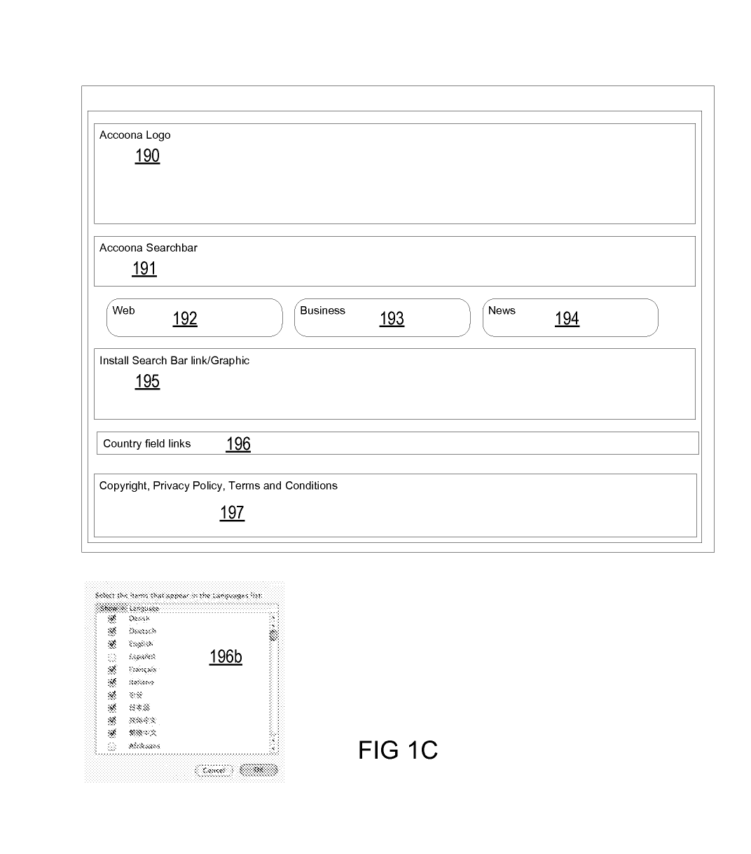

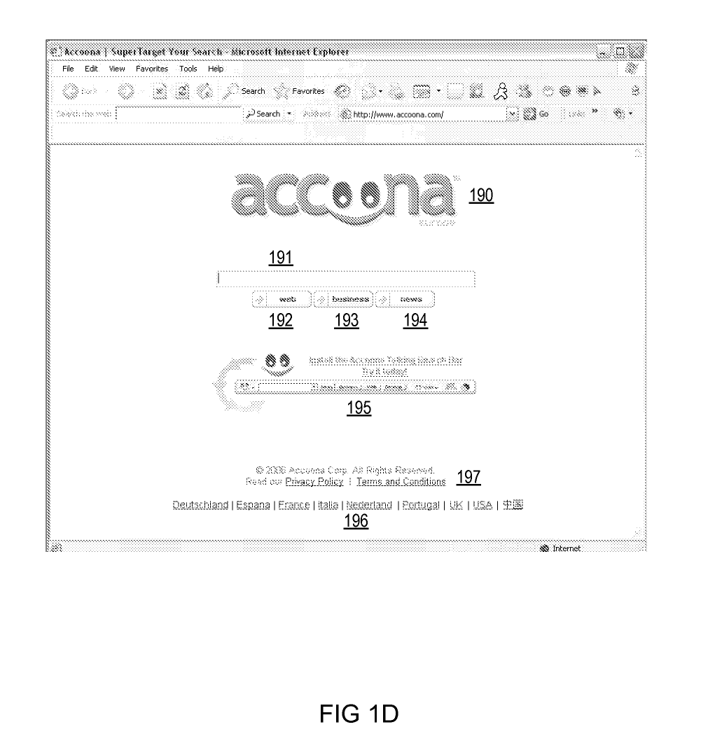

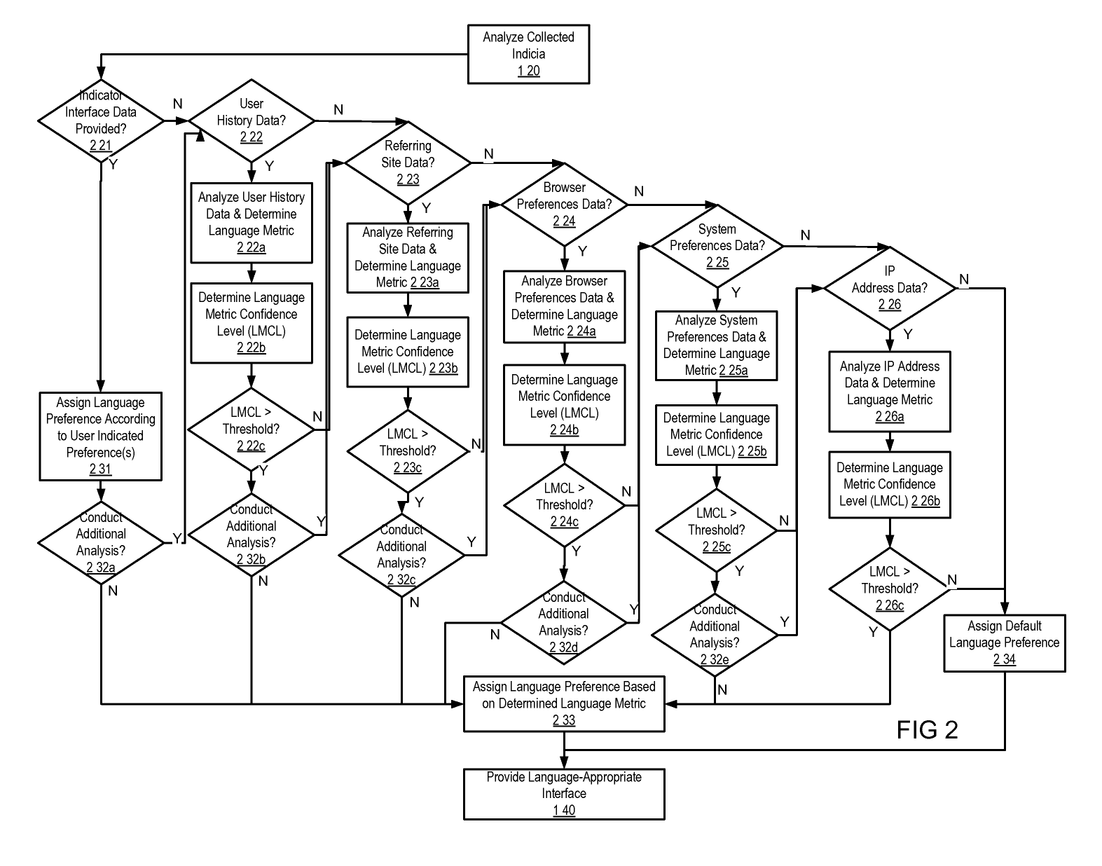

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Language Neutral Search

In one embodiment, a language neutral search system provides a straightforward, unified, and transparent interface that automatically presents users with a search interface that is native to their own language. The user does not need to type in or otherwise provide indication of the specific language in which they wish to engage in data searches.

FIG. 1A provides a logic flow diagram for an embodiment of the language neutral search system. The language neutral search system may collect or obtain one or more pieces of indicia 110 relevant to the user's language (see FIG. 1B for additional detail). Such indicia may include:
a) Browser language preference settings (e.g., the language preference settings in Apple's Safari or Microsoft's Explorer web browsers);
b) Operating system preference settings (e.g., the international language settings in Apple's Macintosh OS X or Microsoft's Windows operating systems);
c) IP addresses (e.g., which may be resolved to a database to discern geographical location);
d) Histories of a users' searches and language preferences (e.g., past searches and/or patterns of searches may be useful in determining the subsequent language preference);
e) The language of the referring and/or previously visited web site that the user was visiting;
f) An indicator of language preference (e.g., a user interface widget such as a pop-up menu indicating language preference);
g) And/or the like.

The system may then analyze the collected indicia 120 and determine or discern the user's language preferences 130. The system may use the determined language preferences to provide a language appropriate search interface 140 to the user (e.g., a language appropriate search homepage). Business rules may employ any of the indicia, either individually or in combination (e.g., the browser setting and the IP address) in determining what language interface to provide to the user. In one embodiment, advertisements and/or the like may be provided to a user prior to the user's search. If advertisements are provided before a search 145, the system will provide language appropriate ads 146 based on the user's determined language preferences.

After the user is presented with a search interface in their own language 140, the user may supply a search token. The system receives the supplied a search token 150, conducts a search in the determined language 160, and supplies search results in the determined language 170. Further, advertising may be provided in the determined language as well 180.

In addition to serving results that are reflective of the user's language and provided business rules, in some embodiments, the language neutral search system provides different “rank profiles” for each language, sorting the results differently 161. In addition to boosting results based on language, the system can change the ranking on any of the other parameters that are available. For example, French speakers might be more interested in obtaining newer documents than German speakers, so such demographic information may be used to select search results with better temporal relevance for users of the French language. As the system may track, discern, and measure (i.e., gauge information) such language based demographic phenomena, search engines may employ such gauging information—the information may be used in contextual (and other) applications. In addition, this gauged information may be used to relate to other information provided, such as ads, spelling hints, and/or the filtering of offensive content. For example, upon discerning a user's language, when a user engages in a search, search results that are language specific and deemed offensive may, optionally, be filtered out. In one embodiment, this language neutral search system determines in which language terms, parameters, and/or the like appear. For example, SIC code business descriptors will appear in English, or French depending on a user's identified language. In one embodiment, the system may utilize one or more aspects of the Artificial Intelligence for Data Searching Applications (AIDSA), discussed in PCT patent application serial no. PCT/05/20545 filed Jun. 10, 2005, entitled “APPARATUS, METHOD AND SYSTEM OF ARTIFICIAL INTELLIGENCE FOR DATA SEARCHING” and herein incorporated by reference. For example, the augmented queries discussed in the above application may be further enhanced by including user language information, as shown below.

Example query construct:

Original:
key1, key2, key3

Augmented:
key1, key1 OR syn1, key1 OR syn2, key2, key2 OR syn1, key2 OR syn2, key3, key3 OR syn1, key3 OR syn2, keyy3 OR syn1 OR syn2, syn1, syn2, syn1 OR syn2

Language Neutral Augmented:
key1, key1 AND language1, key1 OR syn1, (key1 OR syn1) AND language1, key1 OR syn2, (key1 OR syn2) AND language1, key2, key2 AND language1, key2 OR syn1, (key2 OR syn1) AND language1, key2 OR syn2, (key2 OR syn2) AND language1, key3, key3 AND language1, key3 OR syn1, (key3 OR syn1) AND language1, key3 OR syn2, (key3 OR syn2) AND language1, keyy3 OR syn1 OR syn2, (keyy3 OR syn1 OR syn2) AND language1, syn1, syn1 and language1, syn2, syn2 AND language1, syn1 OR syn2, (syn1 OR syn2) AND language1

It should be noted that additional language augmentation may occur. For example, “language1” conjunctional augmentation may take place and thereby increase the above Language Neutral Augmented search with additional permutations. Employing searches with multiple language augmentation may be useful when a user is either from a region and/or has been discerned as using multiple languages (e.g., a user from Switzerland).

FIG. 1B provides additional detail regarding the above-described collection of indicia 110 by the system. In some embodiments, the language neutral search system may query a user's browser 110a for language settings and, if the query produces results, receive and store the language settings 111a. After the system stores the results, or if there are no results, the system may query the user's operating system 110b for language settings. If there results returned, the system receives and stores the query response 111b indicating the operating system language settings. After the system stores the results, or if there are no results, in one embodiment the system may determine 110c and store 111 the user's IP address, which may be used to discern the physical location of the user, and the physical location may be associated with a language preference. In one embodiment, a lookup a tool like GeoS elect by GeoBytes <http://www.geobytes.com/GeoSelect.htm> may be used to identify: country, country code, region, region code, City, city code, city ID, longitude and latitude, time zone, proxy status, capital city, nationality, reference maps, currency, currency code, flag, WHOIS owner information, nearby cities, and/or the like. After the system stores the results, or if there are no results, the system may query a database of user search histories/language preferences 110d and, if there are results, retrieve and store indicated searches/preferences 111d. In such an embodiment, past searches and/or patterns of searches may be used by the system to determine a given user's language preference. After the system stores the results, or if there are no results, the system may determine the language of the referring site and/or previously viewed site 110e. The language of the referring or previously viewed site may be a strong indication of the user's language preferences and may be stored by the system 111e.

After the system stores the results, or if there are no results, in some embodiments, the system may present a user with a language preference indicator interface 110f. For example, the system may provide a user interface widget as a pop-up menu that allows a user to select a language preference and/or provide language specific links on a search interface page. FIGS. 1C and 1D provide a wire frame and screen image diagram, respectively, illustrating a provided search interface page in one embodiment of the language neutral search system. As shown in the figures, the search interface page may have a logo 190, search field 191, three buttons for the type of search (Web 192, Business 193, News 194), a Search Bar install link 195, country and/or language field links 196, and links to the privacy policy and license agreement 197. A Make this your Homepage link may also be provided and directions for Make this Your Homepage may be translated into the appropriate language as necessary. In such an embodiment, a user would specify a preferred language via the language field links 196. The system receives and stores a user's response(s) 111f. In a further embodiment, the system may allow a user to specify more than one language preference and/or order language preferences (i.e., for multi-lingual user). For example, the system may provide a list of check-box items 196b that allows a user to select primary, secondary, tertiary, etc. languages and order the languages; this ordering may be used in subsequent language-preference specific processes performed by the system.

FIG. 2 provides a flow diagram illustrating details of indicia analysis 120 and user language preference determination 130 in an embodiment of the language neutral search system. In order to analyze collected indicia 120, the system determines if language preference indicator interface data is available 221 (as discussed above, the system may provide a user with a language preference indicator interface 110f and store the user's response 111f). If the indicator interface data is available 221, the system may assign a language preference according to the user indicated preferences 231 and provide a language appropriate interface 140. For example, if the user indicated/selected German as their primary language on a provided language indicator pop-up, the system would set the language preference as German and a German language search interface.

If indicator interface data is not available 221 or if additional analysis is to be conducted 232a, the language neutral search system may determine if there is user history data available 222. In one embodiment, the language neutral search system queries its database table of user profiles, which may hold: user names, search preferences, search histories, referring site traversal histories, browser preferences, system preferences, IP addresses, and/or the like. If user history data is available 222, the system may analyze the user history and determine a language metric for the user 222a. In one implementation, the system may analyze the user history to determine a listing of pages previously viewed pages and the language(s) associated with each of the viewed pages. If, for example, 80% of the viewed pages were French language pages (and the remaining 20% were in other languages), the metric would reflect this association. In one implementation, the text of a web page may be compared against word entries in numerous language based dictionaries (e.g., each unique word indexed from the web page) where the number of matches constitutes a numerator and the total number of unique indexed words for the page constitutes the denominator, thereby establishing a percentage of words found in the dictionary of a particular language. In another embodiment, a web page may tag certain segments of text with a language, and this tag may be used as a determining basis (e.g., 100% of the language on the page is based on the tag). Similarly, if 40% of the viewed pages were in German, 50% were in English, and 10% in French, the metric(s) may also indicate the relative proportion of viewed page languages. Additional historical information may be determined by user tracking (e.g., cookies), and previously indicated or determined language information may be stored, retrieved and utilized by the system. In some embodiments, the system may determine a confidence level for the metric 222b indicating the likelihood the metric accurately reflects the user's language preference. In one embodiment, the confidence level is based on a frequency of traversing web pages of singular language (e.g., if the history shows that a user accesses English web pages 80% of the time, an 80% confidence level could be assigned). It should be noted that the language neutral search system may establish a confidence preference for a single language or establish a set and hierarchy of language preferences for the user based on a singular indicator (e.g., by employing a popup or list widget 196, 196b, 221) or it may employ one or more indicators (221, 222, 223, 224, 225, 226) with which to establish and assign a language 233. In some instances, it may be desirable to not conduct any additional analysis when the user clearly specifies a preference 221, 231, 232a, and as such, additional analysis 232b-e might be skipped. However, in the instance where more than one indicator is desirable and/or used, the indicators may be used to establish a hierarchy where there is a language metric confidence level (LMCL) value for each indicator 222c, 223c, 224c, 225c, 226c, and where there is more than one LMCL for a single language (e.g., a historical LMCL of 60% English confidence 222c and LMCL of 80% English confidence for referrals 223c), those values may be averaged (e.g., an average LMCL of 70% English confidence across multiple indicators). As such, if the language metric confidence level is above a predetermined threshold 222c, the system may determine if additional analysis is to be conducted 232b. If there is no additional analysis 232b, then the system assigns language preference according to the determined language metric 233.

If the language metric confidence level is not above the predetermined threshold 222c, if there is no user history data 222, or if there is additional analysis to conduct 232b, then the language neutral search system may determine if there is referring site data 223. If there is referring site data 223, the system may analyze the referring site data and determine a language metric 223a and associated confidence level 223b. In one embodiment, the confidence level is based on a frequency of referral web pages of singular language (e.g., if the history shows that a user is referred from English web pages 70% of the time, an 70% confidence level could be assigned). In one implementation, each indicia may have a corresponding language metric/confidence level, while in another implementation the language metric/confidence level is aggregated for all analyzed indicia. If the language metric confidence level meets or exceeds threshold 223c, the system may determine if additional analysis is to be conducted 232c. If there is no additional analysis 232c, then the system assigns language preference according to the determined language metric 233.

If the language metric confidence level is not above the predetermined threshold 223c, if there is no referring site data 223, or if there is additional analysis to conduct 232c, then the language neutral search system may determine if there is browser preference data 224. If there is browser preferences data 224, the system may analyze the stored browser preferences data and determine or update the language metric 224a and associated confidence level 224b. If the language metric confidence level meets or exceeds threshold 224c, the system may determine if additional analysis is to be conducted 232d. If there is no additional analysis 232d, then the system assigns language preference according to the determined language metric 233.

If the language metric confidence level is not above the predetermined threshold 224c, if there is no browser preferences data 224, or if there is additional analysis to conduct 232d, then the language neutral search system may determine if system preference data is available 225. If there system preference data is available 225, the system may analyze the stored system preferences data and determine or update the language metric 225a and associated confidence level 225b. If the language metric confidence level meets or exceeds threshold 225c, the system may determine if additional analysis is to be conducted 232e. If there is no additional analysis 232e, then the system assigns language preference according to the determined language metric 233.

If the language metric confidence level is not above the predetermined threshold 225c, if there is no system preferences data available 225, or if there is additional analysis to conduct 232d, then the language neutral search system may determine if there is user IP address data 226. If there is user IP address data 226, the system may analyze the IP address data (e.g., determine a geographic origin for the IP address) and determine or update the language metric 226a and associated confidence level 226b. In one embodiment, the language metric may provide information on user language, and, as a consequence, location. For example, if analysis of indicia indicated that the user was a French speaker located in Germany, this information would be indicated in the metric. Such combined language and location information may be particularly useful in providing relevant search results and pertinent advertising. If the language metric confidence level meets or exceeds threshold 226c, the system may assign language preference according to the determined language metric 233. If the language metric confidence level is not above the predetermined threshold 226c or if there is no user IP address data (nor any other indicia) available 226, the system may assign a default language preference 234 (e.g., English).

In other embodiments, different indicia may be analyzed in different order from that described above, and certain indicia may be excluded while additional indicia may be collected and analyzed. In another embodiment, some or all collected indicia may be analyzed and used to determine the appropriate language or languages for a particular user. Depending on the embodiment, different indicia may have weightings that influence how much consideration each is given in determining the language preferences.

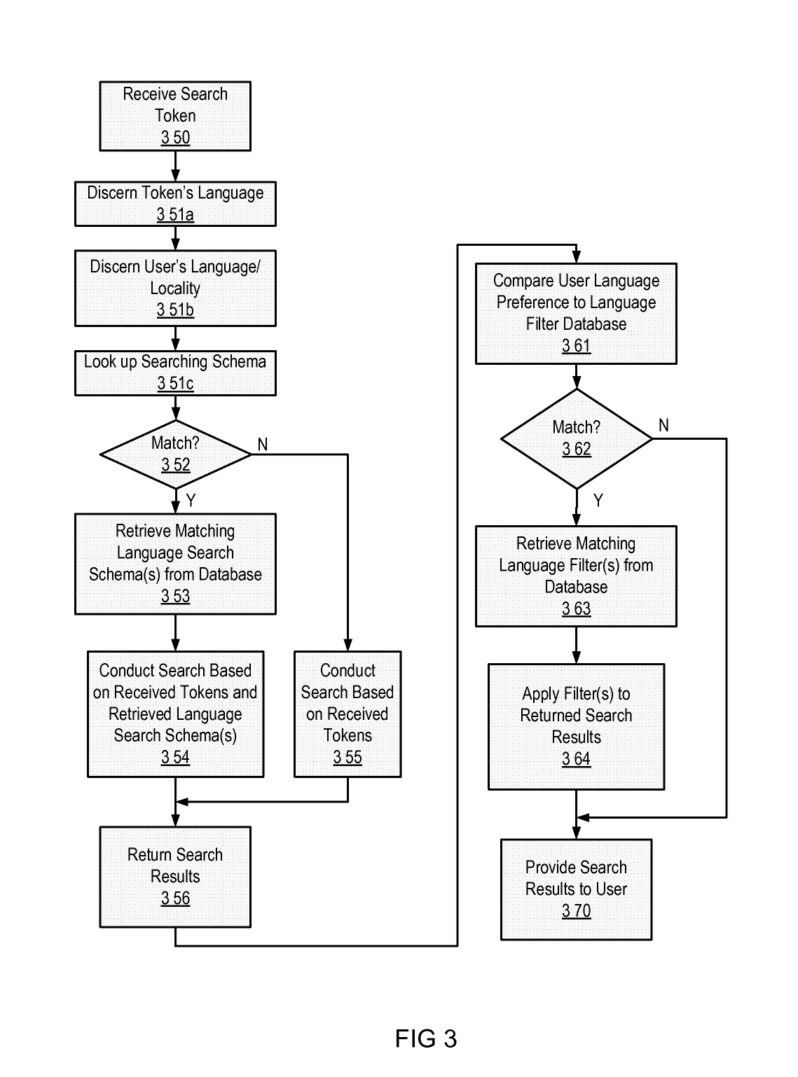

FIG. 3 provides a flow diagram illustrating aspects of searching in an embodiment of the language neutral search system. The system receives a search token from a user 350 (e.g., via the user entering text into the search field 191 and selecting the type of search 192-194, as shown in FIGS. 1C and 1D). The system discerns the search token's language 351a. For example, the system may compare the token to a search token database, and if the token contains one or more words or phrases that are unique to and/or strongly associated with a particular language, the system will store and utilize that information in conducting the search and/or providing search results to a user. If the search terms are associated with multiple languages, a specific language may not necessarily be associated with the search unless additional information was gathered; otherwise, a generic search may be conducted (e.g., a search with a default language such as English). Similarly, if the token contains language-unique words or phrases from different languages, a generic search may be conducted, one language may be given priority, or a combination search may be conducted. For example, if the token (e.g., “schiene reunión”) contains a unique German word and a unique Spanish word, the system may provide German specific results, Spanish specific results, or a combination of both. A combination search may result in different weights be assigned to each language, and if additional information, such as location data, is available, such data may be taken into account when assigning weights and/or providing results. In another embodiment, if a user enters a search token containing a unique German word after previously entering a search token containing a unique Spanish word, one implementation of the system may provide results based on the previously determined language preference while another implementation may provide results based on the language of the new search token.

Based on the search token and/or previously collected indicia, the system may determine the user's language and/or locality 351b and look up one or more corresponding search schemas 351c in a search schema database. Depending on the implementation, the search schemas may be selected according to token language, determined user language, determined user location, and/or a combination thereof. For example, the search schema for a French speaker in Germany may be different from the search schema for a French speaker in France. Similarly, the search schema for a token containing German-specific and English-specific terms may be different from a search schema for a token containing only German-specific terms. If there is a match in the database 352, the system retrieves one or more matching search schemas from the database 353, conducts one or more searches based on the token and retrieved language search schema(s) 354, and returns the search results 356. The search schema, in one embodiment, may be specific to a user and saved in the user profile as a series of search modifier tokens. The schema may provide for information regarding the target language databases to use for user submitted searches (e.g., “English”), the target region for the search (e.g., “Switzerland” because the English speaking user's IP address is determined to be from Switzerland), the language to be used for advertising (e.g., “German” because the user has a history of shopping on German commerce sites), etc. For example, in one embodiment, the XML for search schema may take the following form:

```
<Search_Schema>
    <Schema_ID> ABC123 </Schema_ID>
    <Language_Info>
        <TokenL>
            <Token_Language1> English
            </Token_Language1>
            <Token_Language2> German
            </Token_Language2>
        </TokenL>
        <UserL>
            <User_Language1> German
            </User_Language1>
            <User_Language2> English
            </User_Language2>
            <User_Language3> French
            </User_Language3>
        </UserL>
    </Language_Info>
        <Location_Info> Switzerland
        </Location_Info>
        <Search>
            <Target_Database_Search>  Eng_Database2,
Eng_Database5, Ger_Database3
            </Target_Database_Search>
            <Search_Modifiers> </Search_Modifiers>
        </Search>
        <Advertising>
            <Ad_Language1> German
            </Ad_Language1>
            <Ad_Language2> English
            </Ad_Language2>
        </Advertising>
    </Search_Schema>
```

In one embodiment, the search schema is built up from user supplied indicia over time as has already been discussed in FIG. 2, 233. If there is no match in the search schema database 352, the system may conduct the search according to the received token 355 and return the search results 356.

In some embodiments, the system may compare user language preference(s) to a results language filter database 361 before providing the results to the user. If there is a match found in the results language filter database 362, the system retrieves the matching language filter(s) from the database 363 and applies the filter(s) to the returned search results. For example, if the user's language preference is French, search results that contain French words may be ranked or listed before search results that don't contain French words, or that contain relatively fewer French words. The filtered search results may then be provided to the user 370. In such an example, non-French or French-light search results would be filtered out.

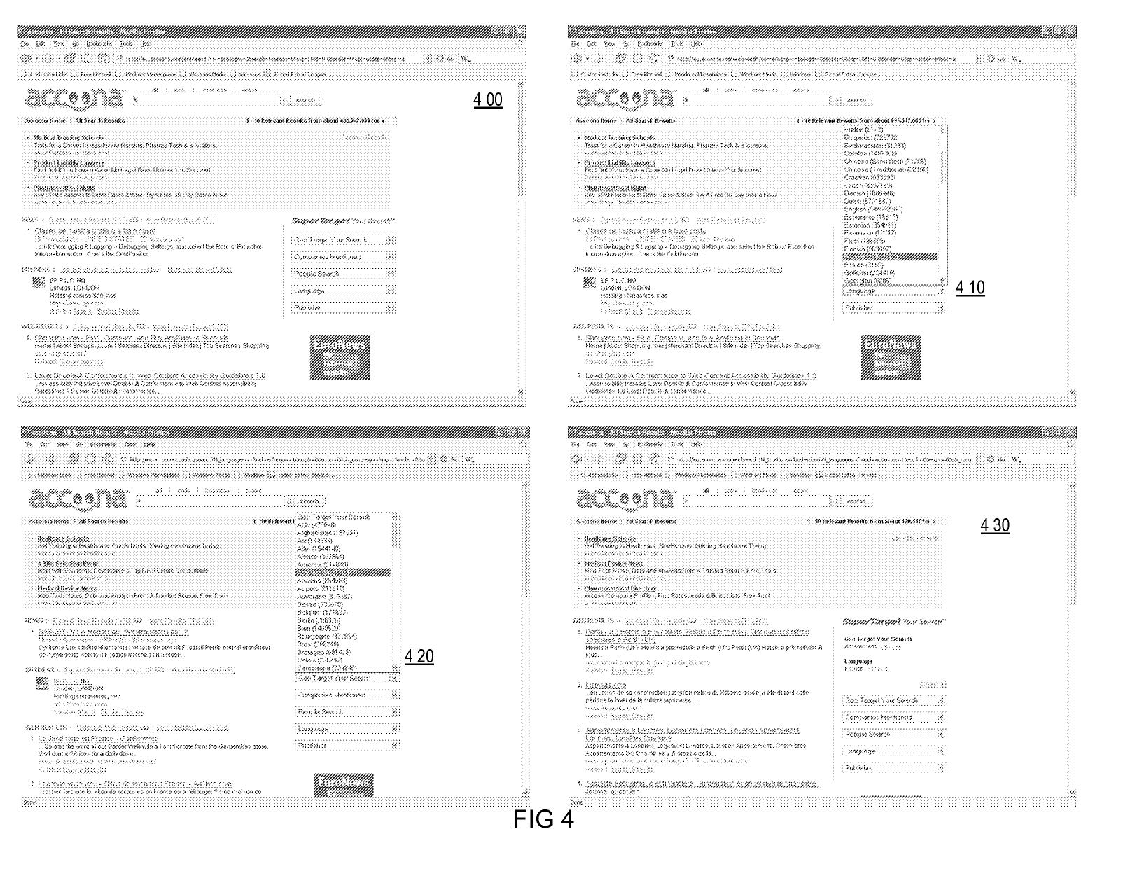

FIG. 4 provides screen image diagrams illustrating aspects of the language neutral search system. The system may provide search results to a user 400, based on a provided search token (e.g., “a”). In some embodiments, the system may allow the user to apply language 410 (e.g., French) and/or location 420 (e.g., Amsterdam) filters to initial search results 400 (e.g., via interface widgets). In some embodiments, the widgets may indicate the number of results that are provided if the filter is applied (e.g., “Amsterdam (170447)”). The system may then apply the indicated filters and/or preferences and provided updated search results 430. The system may also provide user interface widgets or buttons to remove filters or apply additional filters. The system may also collect, store and analyze user interaction to improve subsequent searching and serving functions.

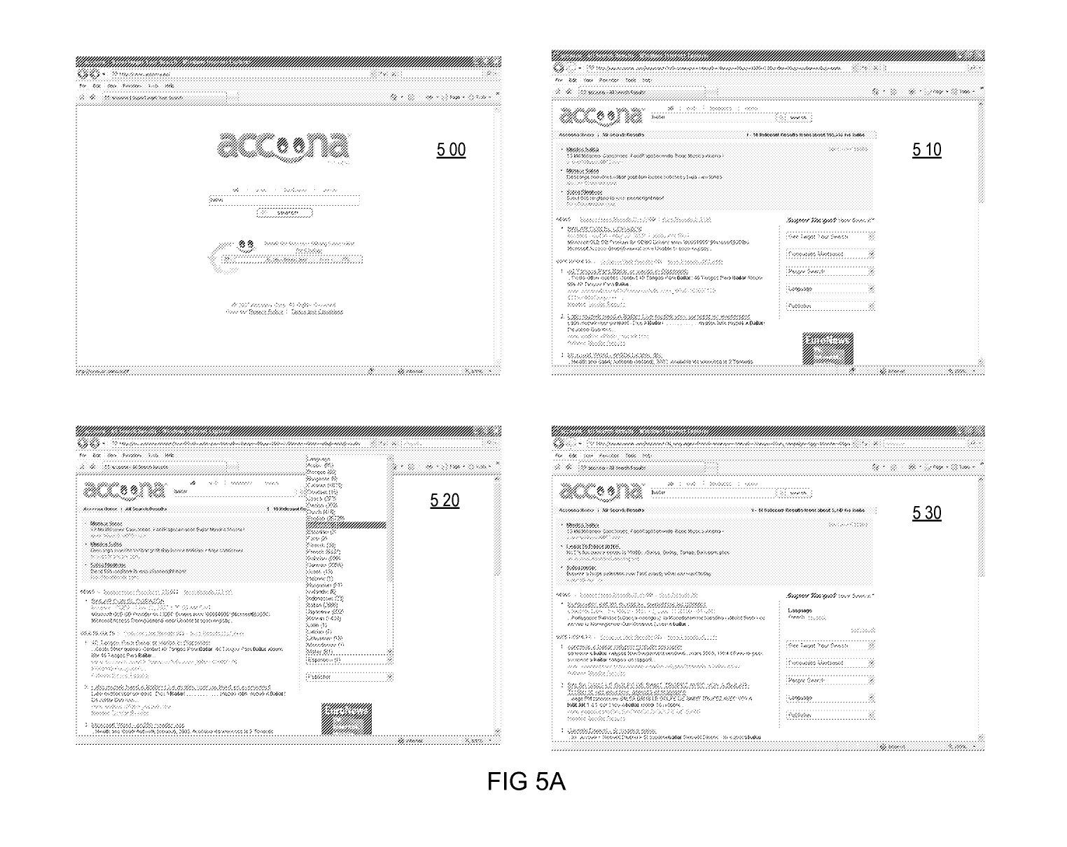

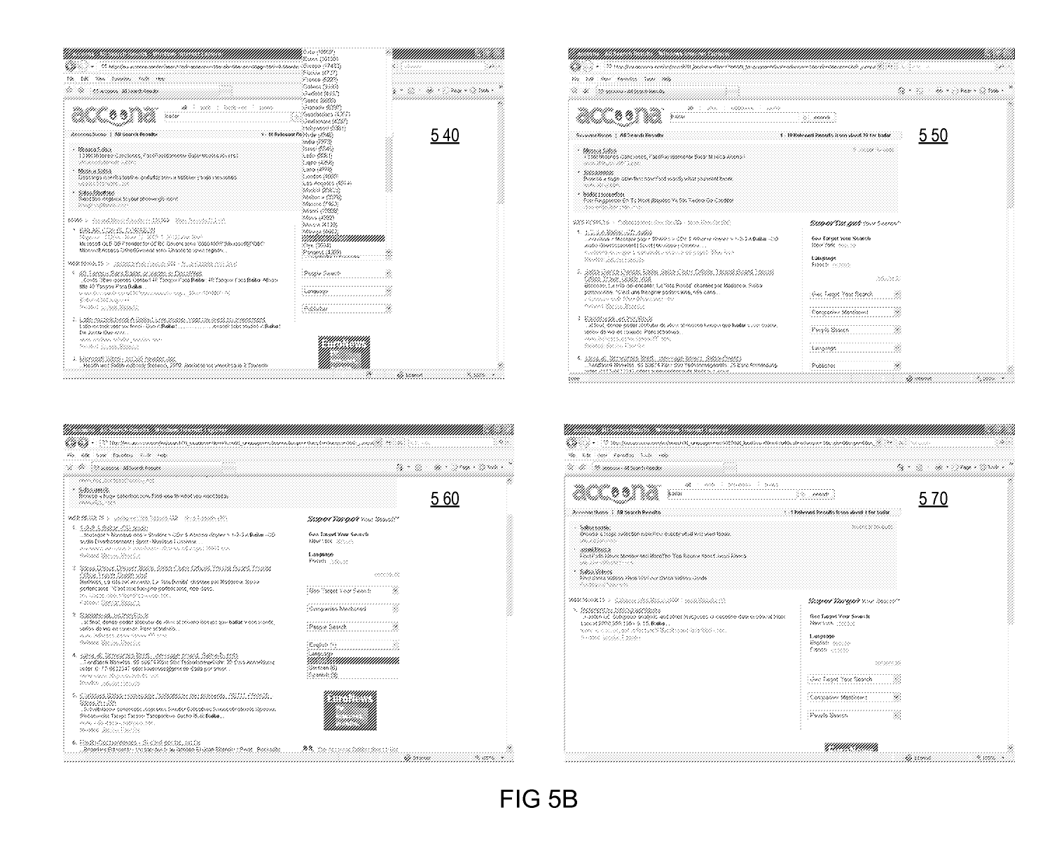

FIGS. 5A-B provides a set of screen image diagrams illustrating additional aspects of the language neutral search system. As shown in FIG. 5A, a user enters a search term (e.g., “bailar”) in a provided search box (as discussed above) 500. The system conducts a search based on the search term and provides the search results to the user 510. The user may then select from a list of languages 520 and, based on the selected language (e.g., French), the system provides updated search results 530. As continued in FIG. 5B, the user may then select a location (e.g., New York) 540, and the system updates the search results and provides them to the user 550. In some embodiments, the user may further select an additional language (e.g., English) 560. Based on the additional input, the system updates and displays the modified search results (e.g., References Bibliographiques) 570.

The language neutral search system is, in one embodiment, particularly useful for query disambiguation in the increasingly “flat world”. Many English words are used naturally in other languages and visa versa. So, for example, if a user is French, and searches for a “restaurant,” the system boosts documents that have that word and are primarily in French. In such a scenario, the system also may return results in the result set that are from non-French documents that use the same word, a synonym, and/or the like in case the user is interested in restaurants in the US. The system allows the user to further refine search results according to language and/or location. In some embodiments, the system may store and analyze searches from users with similar criteria (e.g., language and/or location) to further enhance searching and/or advertising, as discussed in PCT patent application serial no. PCT/05/20545 filed Jun. 10, 2005, entitled “APPARATUS, METHOD AND SYSTEM OF ARTIFICIAL INTELLIGENCE FOR DATA SEARCHING.” By recording such user interactions and characteristics, the system further refines the creation and adaptation of search ontologies for similar users and terms. In one embodiment, the language neutral search system may be implemented with the keyword expander, data selector and/or data ranker of PCT patent application serial no. PCT/05/20545. For example, a search system may be augmented with the language neutral search system to perform language analysis for spidered sites and may use metadata tags, e.g., XML parameter tags and/or field descriptors, to index words within web pages as specific types of data and/or the data may be indexed into specific types of database indexes based on language and/or language/location information. As such additional language/location tags may be used, ontologies will be affected and tracked based on such language/location based information. For example, if users in the UK tend to read results directed towards a meeting place for runners when they employ the term “track meet” and US users tend to read results directed towards foot races when employing the same terms, the very same term may be incorporated differently in ontologies for the two different regions.

### Language Neutral Search Controller

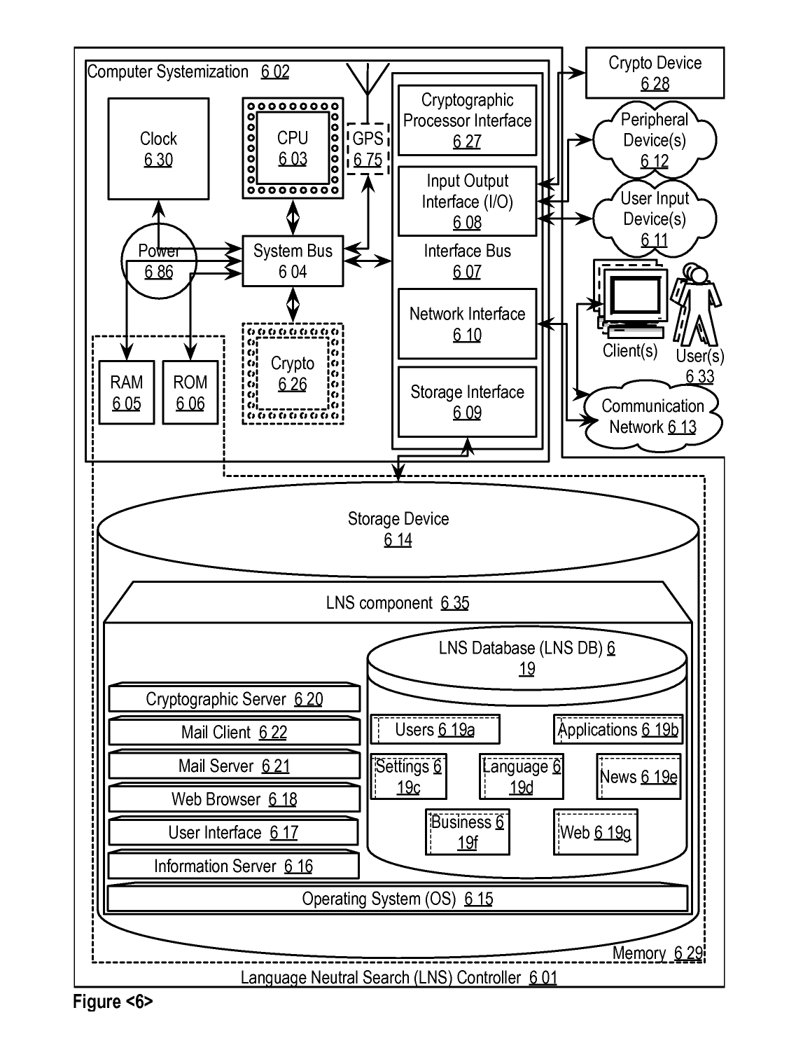

FIG. 6 of the present disclosure illustrates inventive aspects of a language neutral search controller 601 in a block diagram. In this embodiment, the language neutral search controller 601 may serve to aggregate, process, store, search, serve, identify, instruct, generate, match, and/or facilitate interactions with a computer through search technologies, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the language neutral search system controller 601 may be connected to and/or communicate with entities such as, but not limited to: one or more users from user input devices 611; peripheral devices 612; a cryptographic processor device 628; and/or a communications network 613.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The language neutral search system controller 601 may be based on common computer systems that may comprise, but are not limited to, components such as: a computer systemization 602 connected to memory 629.

Computer Systemization

A computer systemization 602 may comprise a clock 630, central processing unit (CPU) 603, a read only memory (ROM) 606, a random access memory (RAM) 605, and/or an interface bus 607, and most frequently, although not necessarily, are all interconnected and/or communicating through a system bus 604. Optionally, the computer systemization may be connected to an internal power source 686. Optionally, a cryptographic processor 626 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the language neutral search system controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 686 is connected to at least one of the interconnected subsequent components of the language neutral search system thereby providing an electric current to all subsequent components. In one example, the power source 686 is connected to the system bus component 604. In an alternative embodiment, an outside power source 686 is provided through a connection across the I/O 608 interface. For example, a USB and/or IEEE 1394 connection carries both data and power across the connection and is therefore a suitable source of power.

Interface Adapters

Interface bus(ses) 607 may accept, connect, and/or communicate to a number of interface adapters, conventionally although not necessarily in the form of adapter cards, such as but not limited to: input output interfaces (I/O) 608, storage interfaces 609, network interfaces 610, and/or the like. Optionally, cryptographic processor interfaces 627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 609 may accept, communicate, and/or connect to a number of storage devices such as, but not limited to: storage devices 614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 610 may accept, communicate, and/or connect to a communications network 613. Through a communications network 613, the language neutral search system controller is accessible through remote clients 633b (e.g., computers with web browsers) by users 633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 610 may be used to engage with various communications network types 613. For example, multiple network interfaces may be employed to allow for the communication over broadcast, multicast, and/or unicast networks.

Input Output interfaces (I/O) 608 may accept, communicate, and/or connect to user input devices 611, peripheral devices 612, cryptographic processor devices 628, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set 145, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 611 may be card readers, dongles, finger print readers, gloves, graphics tablets, joysticks, keyboards, mouse (mice), remote controls, retina readers, trackballs, trackpads, and/or the like.

Peripheral devices 612 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the language neutral search system controller may be embodied as an embedded, dedicated, and/or monitor-less (i.e., headless) device, wherein access would be provided over a network interface connection.

Cryptographic units such as, but not limited to, microcontrollers, processors 626, interfaces 627, and/or devices 628 may be attached, and/or communicate with the language neutral search system controller. A MC68HC16 microcontroller, commonly manufactured by Motorola Inc., may be used for and/or within cryptographic units.

Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 629. However, memory is a fungible technology and resource, thus, any number of memory embodiments may be employed in lieu of or in concert with one another. It is to be understood that the language neutral search system controller and/or a computer systemization may employ various forms of memory 629. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 629 will include ROM 606, RAM 605, and a storage device 614. A storage device 614 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 629 may contain a collection of program and/or database components and/or data such as, but not limited to: operating system component(s) 615 (operating system); information server component(s) 616 (information server); user interface component(s) 617 (user interface); Web browser component(s) 618 (Web browser); database(s) 619; mail server component(s) 621; mail client component(s) 622; cryptographic server component(s) 620 (cryptographic server); the language neutral search system component(s) 635; and/or the like (i.e., collectively a component collection). These components may be stored and accessed from the storage devices and/or from storage devices accessible through an interface bus. Although non-conventional program components such as those in the component collection, typically, are stored in a local storage device 614, they may also be loaded and/or stored in memory such as: peripheral devices, RAM, remote storage facilities through a communications network, ROM, various forms of memory, and/or the like.

Operating System

The operating system component 615 is an executable program component facilitating the operation of the language neutral search system controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the language neutral search system controller to communicate with other entities through a communications network 613. Various communication protocols may be used by the language neutral search system controller as a subcarrier transport mechanism for interaction, such as, but not limited to: multicast, TCP/IP, UDP, unicast, and/or the like.

Information Server

An information server component 616 is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the language neutral search system controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the language neutral search system database 619, operating systems, other program components, user interfaces, Web browsers, and/or the like.

Access to the language neutral search system database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Language neutral search system. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the language neutral search system as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component 617 is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 618 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the language neutral search system enabled nodes. The combined application may be nugatory on systems employing standard Web browsers.

Mail Server

A mail server component 621 is a stored program component that is executed by a CPU 603. The mail server may be a conventional Internet mail server such as, but not limited to sendmail, Microsoft Exchange, and/or the. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the language neutral search system.

Access to the language neutral search system mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 622 is a stored program component that is executed by a CPU 603. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 620 is a stored program component that is executed by a CPU 603, cryptographic processor 626, cryptographic processor interface 627, cryptographic processor device 628, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the language neutral search system may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the language neutral search system component to engage in secure transactions if so desired. The cryptographic component facilitates the secure accessing of resources on the language neutral search system and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Language Neutral Search System Database

The language neutral search system database component 619 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the language neutral search system database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the language neutral search system database is implemented as a data-structure, the use of the language neutral search system database 619 may be integrated into another component such as the language neutral search system component 635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 619 includes several tables 619a-g. A users table 619a includes fields such as, but not limited to: a user name, ip_address, email address, address, profile, user_id, and/or the like. The user table may support and/or track multiple entity accounts on a language neutral search system. An application table 619b includes fields such as, but not limited to: application_id, settings_id (provides ability to have specific settings per application), and/or the like. A settings table 619c includes fields such as, but not limited to: settings_id, browser language, operating system language, desired_current_language, preferred_language_hierarchy_list, application_id, translation_id, IP_address, location_id, and/or the like. A language_translation table 619d includes fields such as, but not limited to: language_id, translation_id, language_schema, search_language_filter and/or the like. A news table 119e includes fields such as, but not limited to: news feed id, news item id, and/or the like. A business table 119f includes fields such as, but not limited to: company_id, contact_info_id, and/or the like. A web table 119g includes fields such as, but not limited to: identifier_id (e.g., web address, digital object identifier, etc.), source_id, date, and/or the like.

In one embodiment, the language neutral search system database may interact with other database systems. For example, employing a distributed database system, queries and data access by language neutral search system component may treat the combination of the language neutral search system database, an integrated data security layer database as a single database entity.

In one embodiment, user programs may contain various user interface primitives, which may serve to update the language neutral search system. Also, various accounts may require custom database tables depending upon the environments and the types of clients the language neutral search system may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 619a-g. The language neutral search system may be configured to keep track of various settings, inputs, and parameters via database controllers.

The language neutral search system database may communicate to and/or with other components in a component collection, including itself, and/or facilities of the like. Most frequently, the language neutral search system database communicates with the language neutral search system component, other program components, and/or the like. The database may contain, retain, and provide information regarding other nodes and data.

The Language Neutral Search System

The language neutral search system component 635 is a stored program component that is executed by a CPU. The language neutral search system component affects accessing, obtaining and the provision of information, services, transactions, and/or the like across various communications networks. As such, the language neutral search system component enables one to access, calculate, engage, exchange, generate, identify, instruct, match, process, search, serve, store, and/or facilitate transactions to promote language neutral searching. In one embodiment, the language neutral search system component incorporates any and/or all combinations of the aspects of the language neutral search system that were discussed in the previous figures. As such, the language neutral search system component enables and provides a straightforward, unified, and transparent interface that automatically presents users with a search interface that is native to their own language.

The language neutral search system component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the language neutral search system server employs a cryptographic server to encrypt and decrypt communications. The language neutral search system component may communicate to and/or with other components in a component collection, including itself, and/or facilities of the like. Most frequently, the language neutral search system component communicates with the language neutral search system database, operating systems, other program components, and/or the like. The language neutral search system may contain, communicate, generate, obtain, and/or provide program component, system, user, and/or data communications, requests, and/or responses.

Distributed Language Neutral Search System

The structure and/or operation of any of the language neutral search system node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the language neutral search system controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. In memory, an interaction interface invokeable by an application program responsive to user selections to invoke application module commands, comprising:
an information bar to display language neutral search results generated from an expanded query that includes user language preference information,
wherein the user language preference information is based on an analysis of collected user indicia, said indicia including:
browser language settings;
operating system language settings;
user IP address data;
user historical data;
referring site data;
language preference indicator interface data;
an ad panel to at least one display ad, wherein the basis for selection of the at least one ad includes user language preference information.

2. In memory, an interaction interface invokeable by an application program responsive to user selections to invoke application module commands, comprising:
an information bar to display language neutral search results generated from an expanded query that includes user language preference information.

3. The interaction interface of claim 2, wherein the user language preference information is based on an analysis of collected user indicia.

4. The interaction interface of claim 3, wherein the collected user indicia includes browser language settings.

5. The interaction interface of claim 3, wherein the collected user indicia includes operating system language settings.

6. The interaction interface of claim 3, wherein the collected user indicia includes user IP address data.

7. The interaction interface of claim 3, wherein the user indicia includes user historical data.

8. The interaction interface of claim 3, wherein the collected user indicia includes referring site data.

9. The interaction interface of claim 3, wherein the collected user indicia includes language preference indicator interface data.

10. The interaction interface of claim 2, wherein the user language preference information is based on a language analysis of a submitted search token.

11. The interaction interface of claim 10, wherein analysis of a submitted search token includes comparing the submitted search token to a language database.

12. The interaction interface of claim 11, wherein the language database contains words that are unique to a language.

13. The interaction interface of claim 11, wherein the language database contains word combinations that are unique to a language.

14. The interaction interface of claim 2, further comprising:
an ad panel to at least one display ad, wherein the basis for selection of the at least one ad includes user language preference information.

15. A processor-implemented method to augment web searches, comprising:
collecting and storing user indicia,
wherein said indicia includes:
browser language settings;
operating system language settings;
user IP address data;
user historical data;
referring site data;
language preference indicator interface data;
determining a user's language preference setting, wherein the determination is based on an analysis of the collected and stored user indicia;
determining a locality of origin;
providing the user with a search interface having a language determined by the user's language preference setting and the determined locality of origin;
receiving a search token from the user;
determining whether at least one language is associated with the search token;
conducting a search according to the received search token,
wherein the search is augmented according to the language preference setting, locality of origin, and search token language;
returning search results;
filtering the search results according to the language preference setting, locality of origin, and search token language; and
providing filtered search results to the user.

16. A processor-implemented method to augment web searches, comprising:
collecting and storing user indicia;
determining a user's language preference setting;
determining a locality of origin;
providing the user with a search interface having a language determined by the user's language preference setting;
receiving a search token from the user;
conducting a search according to the received search token,
wherein the search is augmented according to the language preference setting; and
providing search results to the user.

17. The method of claim 16, wherein collecting and storing user indicia includes:
querying a browser for language settings; and
receiving and storing a query response.

18. The method of claim 16, wherein collecting and storing user indicia includes:
querying an operating system for language settings; and
receiving and storing a query response.

19. The method of claim 16, wherein collecting and storing user indicia includes:
determining and storing a user IP address.

20. The method of claim 16, wherein collecting and storing user indicia includes:
querying a database for user historical information; and
receiving and storing a query response.

21. The method of claim 16, wherein collecting and storing user indicia includes:
determining and storing a referring site language.

22. The method of claim 16, wherein collecting and storing user indicia includes:
presenting the user with a language preference indicator interface; and
receiving and storing user interaction data for the presented interface.

23. A processor-enabled method to search data, comprising:
obtaining a query;
matching terms within the query to words in a language database;
identifying an at least one language related to the matched terms in the language database;
generating an expanded query including the at least one identified related language;
searching memory with the expanded query for matching references;
sorting matching references, wherein sorting employs language preference information; and
providing sorted matching references in response to the obtained query.

24. A processor-enabled method to provide relevant data, comprising:
copying words from a web page at a location;
generating a query from unique words from the web page;
matching terms within the query to words in a language database;
identifying an at least one language related to the matched terms in the language database;
generating an expanded query including the at least one identified related language;
searching memory with the expanded query for matching references;
ranking matching references;
providing ranked matching references in response to the obtained query; and
displaying the ranked references in an information bar in the web browser.

25. A processor-enabled method to provide relevant data, comprising:
receiving search queries from users;
collecting user language indicia from the users;
wherein said indicia includes:
browser language settings;
operating system language settings;
user IP address data;
user historical data;
referring site data;
language preference indicator interface data;
for each search query, finding keywords in a language database with terms from the search query;
modifying the strength of associations between keyword associations in the language database based on an analysis of received search queries and user language indicia, wherein the language augmented associations between keywords results in a language augmented search ontology.

26. The method of claim 25, wherein strength between keyword associations is based on analysis of received search queries and location indicia, wherein the location augmented associations between keywords results in a location augmented search ontology.
